(19) United States
(12) Patent Application Publication
(10) Pub. No.: US 2012/0207878 A1
(43) Pub. Date: Aug. 16, 2012

(54) LOW-FAT OR FAT-FREE YOGHURT, AND PROCESS FOR PRODUCTION THEREOF

(75) Inventors: Noriko MIWA, Kanagawa (JP); Wakako Ohashi, Kanagawa (JP)

(73) Assignees: Amano Enzyme Inc., Nagoya-shi (JP); AJINOMOTO CO. INC, Tokyo (JP)

(21) Appl. No.: 13/372,953

(22) Filed: Feb. 14, 2012

Related U.S. Application Data
(63) Continuation of application No. PCT/JP10/64681, filed on Aug. 30, 2010.

(30) Foreign Application Priority Data
Aug. 31, 2009 (JP) 2009-200888

(51) Int. Cl. A23C 9/127

(52) U.S. Cl. 426/43; 426/583

(57) ABSTRACT

A fat-free or low-fat yoghurt having a rich and creamy texture like yoghurts produced using whole-fat milk may be produced by adding a proper amount of a milk protein, such as a defatted milk powder, that has been deamidated with a protein deamidating enzyme to a fat-free or low-fat raw material milk. Alternatively, a proper amount of a milk protein, such as a defatted milk powder, is added to a fat-free or low-fat raw material milk, and the resulting mixture is subjected to a deamidation treatment with a protein deamidating enzyme so that the deamidation ratio reaches a proper level. In this manner, a fat-free or low-fat milk raw material having a milk protein mass and a deamidation ratio both falling within proper ranges can be prepared, and yoghurt may be produced using the milk raw material.

### CROSS REFERENCES TO RELATED APPLICATIONS

This application is a continuation of International Patent Application No. PCT/JP2010/064681, filed on Aug. 30, 2010, and claims priority to Japanese Patent Application No. 2009-200888, filed on Aug. 31, 2009, both of which are incorporated herein by reference in their entireties.

### BACKGROUND OF THE INVENTION

1. Field of the Invention

The present invention relates to methods for producing a low-fat or fat-free yoghurt having a richness and creamy texture like a yoghurt produced with whole-fat milk, that is, whole-fat yoghurt. The present invention also relates to low-fat or fat-free yoghurts produced by such a method.

2. Discussion of the Background

It is expected for yoghurts to have not only a delicious taste as a foods but also an effect as a health food. In recent years, due to a growing concern about health, the number of consumers who care about the amount of calories in foods has increased; and a demand for products which are “low-fat,” “fat-free,” and “low-calorie” has expanded. However, the taste of dairy products having low amount of a milk fat such as fat-free or low-fat products is very plain, sloppy, and lacking of a full-bodied taste, so that consumers have not been satisfied. For this reason, in order to make up for deliciousness and flavor, a low-fat and fat-free typed yoghurt is supplemented with sugar and a low-sugar typed yoghurt is supplemented with fat, whereby, it is difficult to realize low-calories for such yoghurts. Consequently, it has been desired to develop a technology for maintaining both of fat-free/low-fat and low-calories.

In order to solve the above problems, the following methods have been proposed: a method of making up for a decline of full-bodied taste with animal protein hydrolysate known as a seasoning (see Japanese Patent Kokai Publication No. JP56-124342A, which is incorporated herein by reference in its entirety); a method of using a milk fat globule membrane component (see Japanese Patent Kokai Publication No. JP07-236451A, which is incorporated herein by reference in its entirety); a method of blending a fat-protein complex with an oil-in-water emulsified composition (see Japanese Patent Kokai Publication No. JP08-170A, which is incorporated herein by reference in its entirety); and the like. However, consumer's demands were not satisfied enough with them, because they are expensive due to multiple steps in each method, applicable food products are limited, and further these effects are not satisfactory. In addition, it has been attempted to replace a whole fat or at least a part thereof with using protein series such as “SIMPLESSE”, whey-protein concentrate (see Japanese Patent Kokoku Publication No. JP07-22497B, which is incorporated herein by reference in its entirety). However, the flavor and texture of food products obtained by adding a fat replacing product(s) produced with a conventional method(s) are different from original fat and are not satisfactory, and it has not come to substitute for fat completely.

In addition, gums used widely in yoghurt, such as naturally-derived agar and gelatin, carrageenan, xanthane gum, exert effects on an increase in the strength of the curd, a prevention of whey separation, an advancement of a form maintaining property when preserving a product, and further an improvement of curd structure and the like. However, there are problems that an inherent property of gums influences texture to cause a lack of natural feeling, a display (label) of an additive is required, and a fat-replacing effect of texture is not satisfactory.

In the meanwhile, a protein deamidating enzyme, which acts directly on an amide group in proteins, is an enzyme which catalyzes a reaction of deamidation. Thereby it causes transformation of a glutamine residue into a glutamic acid residue and generation of a carboxylic group, which results in an increase of negative charge, an increase of electrostatic repulsive force, a decrease of isoelectric point, an increase of hydration capability, etc. of protein. As a result, it has been known that various improvements of functionalities such as an increase of solubility of protein and dispersion of protein in water, an improvement of emulsification ability and emulsion stability, etc. are rendered (see Yamaguchi et al., Appl. Environ. Microbiol., 66, p. 3337-3343 (2000); Eur. J. Biochem 268 p. 1410-1421 (2001); Japanese Patent Kokai Publication No. JP-P2000-50887A; Japanese Patent Kokai Publication No. JP-P2001-218590A; Japanese Patent Kokai Publication No. JP-P2003-250460A; and WO2006/075772, which are incorporated herein by reference in their entireties).

Japanese Patent Kokai Publication No. JP-P2000-50887A; Japanese Patent Kokai Publication No. JP-P2003-250460A; and WO2006/075772, which are incorporated herein by reference in their entireties, disclose a method of using a protein deamidating enzyme in food products. Among these documents, there is a description relating an alteration of functional properties of wheat gluten, milk protein (mainly, whey protein) using said enzyme, and especially in WO2006/075772, there is a description relating a texture improving effect as “improvement in smoothness” in the case where the protein deamidating enzyme is used for dairy product such as yoghurt and cheese. However, it is not mentioned about an effect for a fat-free or low-fat yoghurt. That is, conventionally, in manufacturing a fat-free or low-fat yoghurt, a trial of the fat substitution by use of said enzyme, i.e., the trial to put close to richness and creamy texture-like the whole fat yogurt has not been made yet.

### SUMMARY OF THE INVENTION

Accordingly, it is one object of the present invention to provide novel methods for preparing low-fat and far-free yoghurts.

It is another object of the present invention to provide novel method low-fat and far-free yoghurts prepared by such a method.

It is another object of the present invention to provide novel low-fat or fat-free yoghurts which have a richness and creamy texture like a yoghurt produced from a starting material milk in which the amount of fat is not adjusted (whole-fat milk).

It is another object of the present invention to provide novel methods for easily producing such a low-fat or fat-free yoghurt starting from a low-fat or fat-free material milk.

These and other objects, which will become apparent during the following detailed description, have been achieved by the inventors' discovery that physical properties will become remarkably weak, and also it will liquefy, and a rich texture of creaminess will be lost, while the smoothness of yogurt will improve with the advance of the deamidation reaction of the milk protein, in the case where the protein deamidating enzyme (so far known as having the effect as “improvement in smoothness”) is solely used for the low-fat or fat-free material milk. Then, as a result of having repeated research wholeheartedly, the present inventors have found that in the case where the mass of milk protein of the fat-free or low-fat yoghurt is increased to be within a proper range, and the deamidation ratio of milk protein is to be within a proper range, the yogurt having the same creamy texture as whole-fat yogurt is obtained, maintaining the physical properties, even when the fat-free or low-fat material milk is used. More specifically, it has been found that the yogurt having the same creamy texture as whole-fat yogurt is obtained without degradation of physical properties in the case where a proper amount of a milk protein, such as a defatted milk powder, that has been deamidated with a protein deamidating enzyme, is added to a fat-free or low-fat milk raw material, or alternatively, a proper amount of a casein-containing milk protein, such as a defatted milk powder, is added to a fat-free or low-fat milk raw material, and subsequently, the resulting mixture is subjected to a deamidation treatment with a protein deamidating enzyme so that the deamidation ratio reaches a proper level, to prepare the fat-free or low-fat milk raw material mixed-solution, in which the mass of milk protein and the deamidation ratio of milk protein are within a proper range; and then yoghurt is prepared using the milk raw material mixed-solution.

Thus, the present invention provides the following.

(1) A method for producing a yoghurt, comprising:

a) a step of adding a casein-containing milk protein to a fat-free milk in which milk fat content is 0.0% by weight or more and less than 0.5% by weight to prepare a milk raw material mixed-solution in which milk protein content is 4.5% by weight or more and 4.8% by weight or less;

b) a step of adding and acting a protein deamidating enzyme to the milk raw material mixed-solution to prepare a deamidated milk raw material mixed-solution in which a deamidation ratio X of the milk protein in the milk raw material mixed-solution meets a following formula:

−39.3×milk protein content (%)+198≦X (%)≦64;

and

c) a step of adding a starter to the deamidated milk raw material mixed-solution.

(2) A method for producing a yoghurt, comprising:

a) a step of adding a casein-containing milk protein to a fat-free milk in which milk fat content is 0.0% by weight or more and less than 0.5% by weight to prepare a milk raw material mixed-solution in which milk protein content is 4.8% by weight or more and 5.0% by weight or less;

b) a step of adding and acting a protein deamidating enzyme to the milk raw material mixed-solution to prepare a deamidated milk raw material mixed-solution in which a deamidation ratio of the milk protein in the milk raw material mixed-solution is 9% or more and 64% or less; and

c) a step of adding a starter to the deamidated milk raw material mixed-solution.

(3) A method for producing a yoghurt, comprising:

a) a step of adding and acting water and a protein deamidating enzyme to a casein-containing milk protein to prepare a deamidated milk protein;

b) a step of adding the deamidated milk protein to a fat-free milk in which milk fat content is 0.0% by weigh or more and less than 0.5% by weight to prepare a milk raw material mixed-solution in which milk protein content is 4.5% by weight or more and 4.8% by weight or less and a deamidation ratio X of the milk protein in the milk raw material mixed-solution meets a following formula:

−39.3×milk protein content (%)+198≦X (%)≦64

and

c) a step of adding a starter to the milk raw material mixed-solution.

(4) A method for producing a yoghurt, comprising:

a) a step of adding and acting water and a protein deamidating enzyme to a casein-containing milk protein to prepare a deamidated milk protein;

b) a step of adding the deamidated milk protein to a fat-free milk in which milk fat content is 0.0% by weigh or more and less than 0.5% by weight to prepare a milk raw material mixed-solution in which milk protein content is 4.5% by weight or more and 4.8% by weight or less and a deamidation ratio X of the milk protein in the milk raw material mixed-solution is 9% or more and 64% or less; and

c) a step of adding a starter to the milk raw material mixed-solution.

(5) A method for producing a yoghurt, comprising:

a) a step of adding a casein-containing milk protein to a low-fat milk in which milk fat content is 0.5% by weight or more and less than 1.5% by weight to prepare a milk raw material mixed-solution in which milk protein content is 4.0% by weight or more and 4.5% by weight or less;

b) a step of adding and acting a protein deamidating enzyme to the milk raw material mixed-solution to prepare a deamidated milk raw material mixed-solution in which a deamidation ratio X of the milk protein in the milk raw material mixed-solution meets a following formula:

−44.3×milk protein content (%)+201≦X (%)≦64

and

c) a step of adding a starter to the deamidated milk raw material mixed-solution.

(6) A method for producing a yoghurt, comprising:

a) a step of adding and acting water and a protein deamidating enzyme to a casein-containing milk protein to prepare a deamidated milk protein;

b) a step of adding the deamidated milk protein to a low-fat milk in which milk fat content is 0.5% by weight or more and 1.5% by weight or less to prepare a milk raw material mixed-solution in which milk protein content is 4.0% by weight or more and 4.5% by weight or less and a deamidation ratio X of the milk protein in the milk raw material mixed-solution meets a following formula:

−44.3×milk protein content (%)+201≦X (%)≦64

and

c) a step of adding a starter to the milk raw material mixed-solution.

(7) The method according to any one of (1) to (6); wherein the protein deamidating enzyme is an enzyme derived from the genus Chryseobacterium.

(8) The method according to any one of (1) to (6); wherein additive amount of the protein deamidating enzyme is 0.01-100 units per 1 g of the milk protein.

(9) The method according to any one of (1) to (6); wherein the milk protein is defatted milk powder.

(10) A yoghurt produced by the method according to any one of (1) to (6).

According to the present invention, a fat-free or low-fat yoghurt having a richness and creamy texture like a yoghurt produced from a starting material milk in which the amount of fat has not been adjusted (whole-fat milk) can be obtained easily.

### DETAILED DESCRIPTION OF THE PREFERRED EMBODIMENTS

A fat-free milk defined in the present invention is mammalian milk, such as cow milk or goat milk, in which a part of the milk fat portion is removed from the raw milk, and the milk fat content is adjusted to 0.0% by weight or more and less than 0.5% by weight, and a powdered milk and a concentrated milk thereof; and a low-fat milk is a mammalian milk, such as cow milk or goat milk, in which the milk fat content is adjusted to 0.5% by weight or more and 1.5% by weight or less, and a powdered milk and a concentrated milk thereof. In addition, under Japanese compositional standards for milk fat content in milk and the like, low-fat milk includes a milk fat content of 0.5% by weight or more and 1.5% by weight or less, and a fat-free milk includes a milk fat content of less than 0.5% by weight (hereinafter, % indicates % by weight in the case where not written in particular specifically).

In the present invention, the milk protein added to a fat-free or low-fat material milk is a casein-containing milk protein, and is casein or a mixture of casein and whey (defatted milk powder, total milk protein, and the like). Even if ingredients, such as proteins other than milk proteins, inorganic salt, sugars, fats coexist, it is satisfactory at all. Thus, other ingredients, such as proteins other than milk proteins, inorganic salt, sugars, fats, etc., may be added. In addition, the most suitable milk protein is defatted milk powder in which milk is powdered after (partial) defatting with a separator or a milk protein concentrate (MPC) obtainable from a membrane treatment after (partial) defatting.

The kind of the protein deamidating enzyme used for the present invention is not limited so long as it possesses a function of directly acting on an amide group in a protein, so as to cleave a peptide bonding and deamidate the protein without linking. As an example of such an enzyme, a protein deamidating enzyme derived from the genus Chryseobacterium, Flavobacterium, or Empedobacter as disclosed in JP2000-50887A (Reference Document 1, which is incorporated herein by reference in its entirety), JP2001-21850A (Reference Document 2, which is incorporated herein by reference in its entirety), and WO2006/075772 (Reference Document 3, which is incorporated herein by reference in its entirety), a protein-glutaminase, commercially available in the market, derived from the genus Chryseobacterium and the like are exemplified but not limited thereto. Preferably, an enzyme derived from the genus Chryseobacterium is used. As for transglutaminase, it is not included in a protein deamidating enzyme according to the present invention because when acting the transglutaminase on food materials, it causes a cross-linking reaction, with priority, in proteins and almost no deamidating reaction.

A protein deamidating enzyme can be prepared from a culture liquid for microorganism that produces the protein deamidating enzyme. Publicly known separation and purification methods of protein (such as centrifuging, UF concentration, salting-out, various kinds of chromatography with ion-exchanging resin, etc.) can be used as the preparation method of a protein deamidating enzyme. For example, a culture liquid is centrifuged to separate bacteria cells, and then salting-out and chromatography, and the like may be combined to obtain target enzymes. When collecting enzymes from the interior of bacterial cells, bacterial the cells can be crushed by a pressure processing or ultrasonic processing, for example, and then separated and purified as described above to obtain target enzymes. Bacterial cells may be recovered from a culture liquid by filtration or centrifuge, etc. prior to the processing steps above explained (such as crushing of bacterial cells, separation, and purification). The enzyme may be powdered by a drying method such as a freeze drying or vacuum drying, etc., and an appropriate bulking agent or drying auxiliary agent may be used at the drying step.

The activity of the protein deamidating enzyme in the present invention was measured by the following method:

(1) 0.1 ml of an aqueous solution containing the protein deamidating enzyme was added to 1 ml of 0.2M phosphate buffer (pH 6.5) containing 30 mM Z-Gln-Gly, and incubated at 37° C. for 10 minutes, and then the reaction was ceased by adding 1 ml of 0.4M TCA solution. Z in the formula Z-Gln-Gly means a protective group which is a benzyloxycarbonyl group. Thus, Z-Gln-Gly is glutaminyl glycine protected by a benzyloxycarbonyl group (N-benzyloxycarbonyl-L-glutaminylglycine). 0.1 ml of an aqueous solution containing the protein deamidating enzyme was added to a solution containing 1 ml of 0.2M phosphate buffer (pH 6.5) containing 30 mM Z-Gln-Gly, and 1 ml of 0.4M TCA solution, and incubated for 10 minutes at 37° C. to prepare a solution as a blank.

(2) The amount of ammonia generated by the reaction in the solution obtained in (1) was measured by using Ammonia-test Wako (manufactured by Wako Pure Chemical Industries, Ltd.). The ammonia concentration in a reaction solution was determined using a calibration curve indicating the relation between an ammonia concentration and variation of absorbance (at 630 nm) prepared using an ammonia standard solution (ammonium chloride).

(3) The activity of a protein deamidating enzyme, where the amount of enzyme required to produce 1 μmol of ammonia per 1 minute is defined as 1 unit, was calculated by the following formula:

Enzymatic activity (u/mL)=the ammonium concentration in the reaction solution (mg/L)×(1/17.03)×(the volume of the reaction solution/the volume of the enzyme solution)×(1/10)×Df

(17.03: molecular weight of ammonia, 2.1: fluid volume of enzyme reaction system, 0.1: volume of enzyme solution, 10: reaction time, Df: dilution rate of the enzyme solution)

There are two methods to increase the milk protein amount in the milk raw material mixed-solution for the production of the fat-free or low-fat milk yoghurt so as to be within proper range and also to adjust the deamidation ratio of the milk protein so as to be within proper range. In addition, in the Description of the present application, the fat-free or low-fat milk used for the yoghurt preparation may be referred to as the material milk, and the mixed solution prepared by adding and mixing the milk protein into the material milk may be called as the milk raw material mixed-solution.

The first method is a method in which the milk protein such as a defatted milk powder and the like is dissolved into the material milk to prepare the milk raw material mixed-solution, then the protein deamidating enzyme is activated after the total milk protein content of the milk raw material mixed-solution is adjusted so as to be 4.0-5.0% by weight (pre-incubation method). In the present invention, the total milk protein content in the milk raw material mixed-solution may be adjusted so as to be 4.0-5.0% by weight. The milk protein content added to the material milk may be calculated so that the total milk protein content in the milk raw material mixed-solution is 4.5-5.0% by weight when a fat-free yoghurt is produced, and the milk protein content added to the material milk may be calculated so that the total milk protein content in the milk raw material mixed-solution is 4.0-4.5% by weight when a low-fat yoghurt is produced, where the two calculations are based on the milk protein content in the material milk to be used (low-fat or fat-free milk). Furthermore, it can be considered that the milk protein content in yoghurt as the final product is almost the same as the milk protein content in the milk raw material mixed-solution because a change in the milk protein mass from lactic fermentation hardly occurs.

Subsequently, the protein deamidating enzyme is added to the milk raw material mixed-solution for reaction. In the present invention, it is important to perform the reaction so as to obtain an appropriate deamidation ratio according to the milk protein content in the milk raw material mixed-solution, and the enzymatic reaction conditions (such as an amount of the enzyme, reaction time, temperature, pH of the reaction solution, etc.) for achieving such a state may be suitably set, in order that the deamidation ratio of the milk protein in the milk raw material mixed-solution is to be within a proper range. For example, in a case where the amount of enzyme is low, although the reaction time may be elongated, the general addition amount of the protein deamidating enzyme is preferably 0.01-100 units, and more preferably 0.1-25 units, per 1 g (dried weight) of milk protein. A preferable reaction temperature is 5 to 80° C., and more preferably 20 to 60° C. A preferable pH for the reaction solution is 2 to 10, and more preferably 4 to 8. A preferable reaction time is from 10 seconds to 48 hours, and more preferably from 10 minutes to 24 hours.

Although the proper deamidation ratio in the present invention is different depending on the milk protein content and the milk fat content in the milk raw material mixed-solution, the deamidation ratio (X) of the milk protein in the milk raw material mixed-solution may meet the following Formula (A), more preferably the following Formula (B) in a case where the milk protein content in the milk raw material mixed-solution (mixed-solution of the material milk and the added milk protein) is adjusted to 4.5-4.8% by weight for a fat-free yoghurt.

−39.3×milk protein content (%) in the milk raw material mixed-solution+198≦X (%)≦64 Formula (A):

−39.3×milk protein content (%) in the milk raw material mixed-solution+203≦X (%)≦64 Formula (B):

For example, the deamidation ratio is preferably 21-64%, and more preferably 26-64%, when a fat-free yoghurt is produced with a milk raw material mixed-solution having a milk protein content of 4.5% and a milk fat content of 0.1%. The deamidation ratio is preferably 15-64%, and more preferably 20-64%, when a fat-free yoghurt is produced with a milk raw material mixed-solution having a milk protein content of 4.65% and a milk fat content of 0.1%. The deamidation ratio is preferably 9-64%, and more preferably 14-64%, when a fat-free yoghurt is produced with a milk raw material mixed-solution having a milk protein content of 4.8% and a milk fat content of 0.1%.

The deamidation ratio (X) of the milk protein in the milk raw material mixed-solution is preferably 9-64%, and more preferably 14-64%, when the milk protein content in the milk raw material mixed-solution is adjusted to 4.8-5.0% by weight for a fat-free yoghurt.

The deamidation ratio (X) of the milk protein in the milk raw material mixed-solution may meet the following Formula (C), more preferably the following Formula (D), when the milk protein content in the milk raw material mixed-solution is adjusted to 4.0-4.5% by weight for a low-fat yoghurt.

−44.3×milk protein content (%) in the milk raw material mixed-solution+201≦X (%)≦64 Formula (C):

−44.3×milk protein content (%) in the milk raw material mixed-solution+206≦X (%)≦64 Formula (D):

For example, when a low-fat yoghurt is produced with a milk raw material mixed-solution having a milk protein content of 4.0% and a milk fat content of 1.0%, the deamidation ratio is preferably 24-64%, and more preferably 29-64%. When a low-fat yoghurt is produced with a milk raw material mixed-solution having a milk protein content of 4.15% and a milk fat content of 1.0%, the deamidation ratio is preferably 17-64%, and more preferably 22-64%. When a low-fat yoghurt is produced with a milk raw material mixed-solution having a milk protein content of 4.3% and a milk fat content of 1.0%, the deamidation ratio is preferably 11-64%, and more preferably 16-64%. When a low-fat yoghurt is produced with a milk raw material mixed-solution having a milk protein content of 4.45% and a milk fat content of 1.0%, the deamidation ratio is preferably 4-64%, and more preferably 9-64%.

The second method is a method of adding a deamidated milk protein which has been previously modified with the protein deamidating enzyme (deamidated milk protein addition method). That is, it is a method such that a solution of milk protein such as defatted milk powder is treated with the protein deamidating enzyme to prepare a deamidated milk protein, and a dried-powdered deamidated milk protein, which is obtained by drying and powdering the deamidated milk protein, is added to the fat-free or low-fat milk to adjust the total milk protein content in the milk raw material mixed-solution so as to be 4.0-5.0% by weight and to also adjust the deamidation ratio of the milk protein in the milk raw material mixed-solution so as to be in the proper range. Reaction conditions may be controlled appropriately to obtain an appropriate deamidation ratio, the additive amount of the protein deamidating enzyme is preferably 0.01-100 units, and more preferably 0.1-25 units per 1 g (dried weight) the milk protein, while the protein deamidating enzyme reaction conditions (such as amount of enzyme, reaction time, temperature, pH of the reaction solution, etc.) for preparing the deamidated milk protein are not particularly limited. A preferable reaction temperature is 5 to 80° C., and more preferably 20 to 60° C. A preferable pH for the reaction solution is 2 to 10, and more preferably 4 to 8. A preferable reaction time is from 10 seconds to 48 hours, and more preferably from 10 minutes to 24 hours. In addition, the proper deamidation ratio of the milk protein in the milk raw material mixed-solution is the same as that of the pre-incubation method described above.

The deamidation ratio used in the present invention indicates to what degree the glutamine residues in all the milk proteins contained in the milk raw material mixed-solution or yoghurt as the final product have been deamidated with the protein deamidating enzyme. Given that the state where all glutamines in proteins in the milk raw material mixed-solution are deamidated is 100%. In a case where 13 units of the enzyme is added to 1 g of the milk protein and the resulting mixture is subjected to react at 55° C. for an hour, the deamidation reaction reaches saturation. Thereby, a maximum reaction volume (amount of ammonia) which shows 100% of the deamidation ratio can be obtained. That is, the deamidation ratio is obtained based on the following Formula (E) for the pre-incubation method, and the following Formula (F) for the deamidated milk protein addition method.

The deamidation ratio (%)=[an amount of ammonia in the milk raw material mixed-solution after allowing the protein deamidating enzyme to act on the milk raw material mixed-solution]÷[an amount of ammonia in the milk raw material mixed-solution after allowing the same enzyme in an amount of 13 units per 1 g milk protein to act on the same milk raw material mixed-solution for an hour at 55° C.]×100 Formula (E):

The deamidation ratio (%)=[an amount of ammonia in the milk protein solution after allowing the protein deamidating enzyme to act on the milk protein solution]÷[an amount of ammonia in the milk protein solution after allowing the same enzyme in an amount of 13 units per 1 g milk protein to act on the same milk protein mixed-solution for an hour at 55° C.]×100×[the content of the added milk protein]÷[the content of the protein in the material milk+the content of the added milk protein] Formula (F):

The amount of ammonia in the milk raw material mixed-solution or in the milk protein solution can be measured by commercially available ammonia measuring kit after performing deproteinization operation by an acid (trichloroacetic acid, perchloric acid or the like). For example, to the milk raw material mixed-solution (as for the pre-incubation method) or the milk protein solution (as for the deamidated milk protein addition method) is added 12% trichloroacetic acid of the same quantity as said solution for deproteinization (the enzymatic reaction is also stopped at this time). Then, the amount of ammonia in the supernatant obtained by centrifugation (12,000 rpm, 5° C., 5 minutes) is measured using F-kit (Roche). In detail, 10 μl of the supernatant and 190 μl of 0.1M triethanolamine buffer (pH 8.0) are added to 100 μl of liquid reagent II (a component of the F-kit) and kept for 5 minutes at room temperature. After that an absorbance at 340 nm is measured using 100 μl of the resultant solution. 1.0 μl of reagent III (a component of the F-kit, glutamate dehydrogenase) is added to the remaining 200 μl of the solution and kept for 20 minutes at room temperature, and then an absorbance at 340 nm is measured using the 200 μl of the solution. The ammonia concentration in the supernatant is determined using a calibration curve indicating the relation between ammonia concentration and variation of absorbance (at 340 nm) prepared using an ammonia standard solution included with the F-kit, and thereby the amount of ammonia in the milk raw material mixed-solution or the milk protein solution is determined. In addition, in a case where the measurement is out of the range of standard curve, the solution for measurement is diluted with water, and then measured.

The low-fat or fat-free yoghurt of the present invention is produced by using the milk raw material mixed-solution prepared by the method described above, in which the milk protein amount and the deamidation ratio are within the proper range. The process for producing a yoghurt may be a regular method; for example, the milk raw material mixed-solution, in which the milk protein content and the deamidation ratio are within the proper range, may be homogenized with a homogenizer or the like, by adding raw materials such as sugar and flavor thereto as necessary. Then, after sterilizing and cooling, a starter (lactobacillus, yoghurt in which useful lactobacillus remains, or the like) is added into the above sterilized and cooled solution, and then the low-fat or fat-free yoghurt may be produced by fermenting after charging the resulting mixture into a container, or by charging the fermented mixture into a container after fermenting the resulting mixture in a tank. In addition, yoghurt may be either set-type or stirred-type. The yoghurt may be produced from the milk raw material mixed-solution by the methods described in US 2007/0134374 and US 2009/0068312, which are incorporated herein by reference in their entireties.

Other features of the invention will become apparent in the course of the following descriptions of exemplary embodiments which are given for illustration of the invention and are not intended to be limiting thereof.

### EXAMPLES

### Example 1

The low-heat defatted milk powder (Yotsuba NyugyoCo., protein 35.6%) was added to commercially available fat-free milk (Koiwai fat-free milk, Kiwai Nyugyo Co., milk fat 0.1%, protein 3.5%) to adjust the protein content to 4.50%, 4.65%, 4.80%, and 4.95%, and then the protein glutaminase (manufactured by Amano Enzyme Inc., 500 U/g, derived from genus Chryseobacterium; hereinafter abbreviated as PG) solution (60 U/ml) were added in amounts of 0.5 or 6.0 U per 1 g of protein in milk thereto, respectively, and then subjected to reaction at 55° C. for 60 minutes. Subsequently, the enzyme was deactivated by heating the resulting mixtures at 95° C. for 2 minutes in a boiling bath, and then the resultant was cooled to obtain fat-free milks having different deamidation ratios. PG was added by 15 U per 1 g of protein in milk to the above obtained milk, and the milk with PG was reacted with the same condition (reaction at 55° C. for 60 minutes) to measure an amount of ammonia when the deamidation reaction reached almost saturation, provided that the deamidation ratio is 100%. The amount of ammonia in each PG treated sample with adjusted protein amount was measured in accordance with the method described above. As the result, each sample was PG treated fat-free milk, in which the deamidation ratios were 74.5%, 75.2%, 64.8%, 32.5%, 26.0%, and 20.1% for the protein content of 4.5%; the deamidation ratios were 27.2%, 20.6%, and 13.7% for the protein content of 4.65%; the deamidation ratios were 27.5%, 22.3%, 14.4%, and 8.3% for the protein content of 4.8%; and the deamidation ratios were 65.4%, 14.4%, and 8.1% for the protein content of 4.95%, respectively. In addition, fat-free milk (in which the deamidation ratio was 0%) treated similarly except for PG addition was used as a control product.

These protein adjusted fat-free milks having different deamidation ratios were cooled to 47° C., then the starter (Christian Hansen DVS YC-370, 17.7 mg/ml of fat-free milk) was added thereto, stirred completely and poured into sample cups in an amount of 40 g per cup, and then the cups were fermented in a thermostatic bath at 44° C. About 4 hours later, the fermentation was stopped by transferring them into a refrigerator when the pH became 4.6, and stationary-type yoghurts (also called as set-yoghurt) were obtained. In addition, the low-heat defatted milk powder (Yotsuba NyugyoCo., protein 35.6%) was added to commercially available whole-fat milk (Magokoro Rakuno 3.6 Gyunyu, Takanashi Nyugyo Co., milk fat 3.7%, protein 3.2%), and the protein content was adjusted to 3.9%, and the yoghurt prepared similarly except for PG addition was used as a target product.

The next day, as a measurement of the physical property of yoghurt returned to normal temperature, the adhesiveness thereof was measured by the texture analyzer (Stable Microsystems TX-TX2i). Then, they were cooled again in a refrigerator, and subjected to a sensory test by a panel of 5 skilled persons. The results are shown in Table 1. As shown in Table 1, as compared to control and comparative products, the surface roughness disappeared, and the texture of creaminess and smoothness were equivalent to or higher than the whole-fat yogurt in the products of the present invention in which the deamidation ratio was 26.0% or more at the protein content of 4.5%; the deamidation ratio was 20.6% or more at the protein content of 4.65%; the deamidation ratio was 14.4% or more at the protein content of 4.8%; the deamidation ratio was 14.4% or more at the protein content of 4.95%. Regarding the adhesiveness which is one of indexes of physical properties, according to research and development so far, it has been recognized that the texture of creaminess and smoothness of the sensory test and the adhesiveness have positive correlation. For example, in the fat-free yoghurt (protein 4.3%), the sensory test of the texture of creaminess and smoothness on a scale of ten grades shows point 1 which is low in the texture of creaminess and smoothness, and the physical property value of the adhesiveness is also 4.2, and in the low-fat yoghurt (fat 1%, protein 4.3%), the sensory test of the texture of creaminess and smoothness is point 3 and the adhesiveness is 4.9, and in the whole-fat yoghurt (fat 3.7%, protein 3.9%), the sensory test of the texture of creaminess and smoothness is point 6 and the adhesiveness is 5.8. Thus, the value of the adhesiveness also becomes high as the value of the sensory test becomes high. The adhesiveness has been indicated as an index of the texture of creaminess and smoothness in the present specification, too. It has been recognized that the product of the present invention is superior to point 5.4 of the whole-fat yoghurt, the control product and comparative product regarding the adhesiveness, and it is creamy and smooth from the point of view of the physical property value, too. In addition, the sample in which PG additive amount was large and the deamidation ratio was 65% or more had a high value of adhesiveness, whereas it was too soft and there was a fat separation in case of the low-fat, and it became unfavorable texture different from the whole-fat yoghurt.

TABLE 1

| Protein | Sample | PG additive | Deamidation | | Comment for | Overall |
|---|---|---|---|---|---|---|
| content (%) | product | amount (u/gp) | ratio (%) | Adhesiveness | Sensory test | evaluation |
| 3.9 | Target product | 0.0 | 0.0 | 5.44 | Creamy and smooth | — |
| | (whole-fat) | | | | | |
| 4.50 | Comparative | 6.0 | 74.5 | 8.22 | Although it is smooth, | X |
| | product | | | | it has hardly solidified. | |
| | | | | | Hard to mention that it | |
| | | | | | has the same texture as | |
| | | | | | whole-fat. | |
| | Comparative | 4.5 | 64.8 | 8.42 | Although it is smooth, | X |
| | product | | | | it is too soft. Thus, | |
| | | | | | hard to mention that it | |
| | | | | | has the same texture as | |
| | | | | | whole-fat. | |
| | Product of | 2.5 | 32.5 | 6.76 | It is creamy enough and | ⊚ |
| | the present | | | | smooth. It is soft. | |
| | invention | | | | | |
| | Product of | 2.0 | 26.0 | 6.68 | It is creamy and smooth. | ◯ |
| | the present | | | | It is slightly soft. | |
| | invention | | | | | |
| | Comparative | 1.5 | 20.1 | 4.83 | There is roughness a | X |
| | product | | | | little and smoothness | |
| | | | | | is also weak. | |
| | Control | 0.0 | 0.0 | 4.53 | Rough. Hardness is | X |
| | product | | | | almost equivalent to | |
| | | | | | whole-fat. | |
| 4.65 | Product of | 2.0 | 27.2 | 6.65 | Texture of creaminess | ⊚ |
| | the present | | | | and smoothness are | |
| | invention | | | | sufficiently exceeding. | |
| | | | | | It is soft. | |
| | Product of | 1.5 | 20.6 | 6.50 | Almost equivalent to | ◯ |
| | the present | | | | whole-fat (in both of | |
| | invention | | | | smoothness and hard- | |
| | | | | | ness). | |
| | Comparative | 1.0 | 13.7 | 5.31 | Although it is solid, | X |
| | product | | | | there is roughness a | |
| | | | | | little and it is not | |
| | | | | | smooth. | |
| | Control | 0.0 | 0.0 | 4.81 | It is slightly hard | X |
| | product | | | | and rough. | |
| 4.80 | Product of | 2.0 | 27.5 | 7.25 | Creaminess and smooth- | |
| | the present | | | | ness exceeding whole- | |
| | invention | | | | fat. Slightly soft. | |
| | Product of | 1.5 | 22.3 | 7.05 | Sufficient in texture | ⊚ |
| | the present | | | | of creaminess and | |
| | invention | | | | smoothness. Slightly | |
| | | | | | hard. | |
| | Product of | 1.0 | 14.4 | 6.30 | Texture almost | ◯ |
| | the present | | | | equivalent to whole- | |
| | invention | | | | fat (There is a dense | |
| | | | | | feeling and it exceeds | |
| | | | | | whole-fat.). | |
| | Comparative | 0.5 | 8.3 | 5.43 | It is rough and hard. | X |
| | product | | | | Weak in effect although | |
| | | | | | there is smoothness a | |
| | | | | | little. | |
| | Control | 0.0 | 0.0 | 4.88 | It feels hard and tight, | X |
| | product | | | | and is rough. | |
| 4.95 | Comparative | 6.0 | 75.2 | 8.62 | Although it is smooth, | X |
| | product | | | | it has hardly solidified. | |
| | | | | | Hard to mention that it | |
| | | | | | has the same texture as | |
| | | | | | whole-fat. | |
| | Comparative | 4.5 | 65.4 | 7.7 | Although it is smooth, | X |
| | product | | | | it is too soft, and its | |
| | | | | | texture is different | |
| | | | | | from whole-fat. | |
| | Product of | 1.0 | 14.4 | 6.43 | Almost equivalent to | ◯ |
| | the present | | | | whole-fat (although | |
| | invention | | | | smoothness is a little | |
| | | | | | weak, there is no great | |
| | | | | | difference). | |
| | Comparative | 0.5 | 8.1 | 5.44 | It is rough and hard | X |
| | product | | | | (although smoothness is | |
| | | | | | a little weak, there is | |
| | | | | | no great difference). | |
| | Control | 0.0 | 0.0 | 5.19 | Although it is hard with | X |
| | product | | | | a dense feeling, there | |
| | | | | | is much protein and it is | |
| | | | | | rough. There is protein | |
| | | | | | smell. | |

Overall: evaluation: evaluative standard (Re: texture of creaminess, smoothness)
X: inferior to whole-fat yoghurt
◯: equivalent to whole-fat yoghurt
⊚: a little superior to whole-fat yoghurt
: clearly superior to whole-fat yoghurt

### Example 2

The low-heat defatted milk powder (Yotsuba Nyugyo Co., protein 35.6%) was added to commercially available low-fat milk (raw-milk based low-fat milk, Takanashi Nyugyo Co., milk fat 1.0%, protein 3.3%) to adjust the protein content to 4.0%, 4.15%, 4.3%, and 4.45%, and then the PG solution (60 U/ml) was added in an amount of 0.5 or 6.0 U per 1 g of protein in the milk thereto, respectively, followed by reaction at 55° C. for 60 minutes. Subsequently, the enzyme was deactivated by heating the resulting mixtures at 95° C. for 2 minutes in a boiling bath, and then the resultant was cooled to obtain low-fat milks having different deamidation ratios. The deamidation ratio in each PG treated milk was measured using the same method as the Example 1. As a result, each sample was PG treated low-fat milk, in which the deamidation ratios were 28.6% and 22.9% for 4.0% of protein; the deamidation ratios were 30.2%, 24.8%, and 15.4% for 4.15% of protein; the deamidation ratios were 30.4%, 23.7%, 15.6%, and 9.5% for 4.3% of protein; and the deamidation ratios were 16.2% and 9.5% for 4.45% of protein, respectively. In addition, the low-fat milk treated similarly except for PG addition was used as a control product.

These protein adjusted low-fat milks having different deamidation ratios were cooled to 47° C., then the starter (Christian Hansen DVS YC-370 17.7 mg/ml of low-fat milk) was added thereto, stirred completely and poured into sample cups in an amount of 40 g per cup, followed by fermentation in a thermostatic bath at 44°. About 4 hours later, the fermentation was stopped by transferring them into a refrigerator when the pH became 4.6, and set-yoghurts were obtained. In addition, the target product in Example 1 was used as a target product.

The next day, as a measurement of physical property of yoghurt returned to normal temperature, the adhesiveness thereof was measured by the texture analyzer. Then, they were cooled again in a refrigerator, and subjected to a sensory test by a panel of 5 skilled persons. The results are shown in Table 2. As shown in Table 2, as compared to control and comparative products, the surface roughness disappeared, and the texture of creaminess and smoothness were equivalent to or higher than the whole-fat yogurt in the products of the present invention having the condition that the deamidation ratio was 28.6% or more at 4.0% of protein; the deamidation ratio was 24.8% or more at 4.15% of protein; the deamidation ratio was 15.6% or more at 4.3% of protein; the deamidation ratio was 9.5% or more at 4.45% of protein. It was recognized that the products of the present invention were superior to 5.4 of the whole-fat yoghurt, the control product and comparative product also regarding the adhesiveness, and it was creamy and smooth from the point of view of the physical property value, too. In addition, the sample in which PG additive amount was large and the deamidation ratio was 65% or more had a high value of adhesiveness; however, it was too soft and there was a fat separation in case of the low-fat, resulting in an unfavorable texture different from the whole-fat yoghurt.

TABLE 2

| Protein | Sample | PG additive | Deamidation | | Comment for | Overall |
|---|---|---|---|---|---|---|
| content (%) | product | amount (u/gp) | ratio (%) | Adhesiveness | Sensory test | evaluation |
| 3.9 | Target product | 0.0 | 0.0 | 5.44 | Creamy and smoothness | — |
| 4.00 | Comparative | 6.0 | 77.1 | 7.16 | Although it is smooth, | X |
| | product | | | | it has not solidified. | |
| | | | | | Different texture from | |
| | | | | | that of whole-fat. Fat | |
| | | | | | is also separated. | |
| | Comparative | 4.5 | 65.8 | 7.2 | It is smooth and too | X |
| | product | | | | soft, so that texture | |
| | | | | | is different from that | |
| | | | | | of whole-fat. Fat is | |
| | | | | | also separated. | |
| | Product of | 2.0 | 28.6 | 5.59 | Although there are a | ◯ |
| | the present | | | | texture of creaminess | |
| | invention | | | | and smoothness, it is | |
| | | | | | a little softly and | |
| | | | | | light. | |
| | Comparative | 1.5 | 22.9 | 5.39 | Although it is slightly | X |
| | product | | | | smooth, it is weak and | |
| | | | | | there is roughness. | |
| | Control | 0.0 | 0 | 4.36 | It is soft and watery | X |
| | product | | | | and there is roughness. | |
| 4.15 | Product of | 2.0 | 30.2 | 5.88 | Sufficient texture of | ⊚ |
| | the present | | | | creaminess and smooth- | |
| | invention | | | | ness. Slightly soft. | |
| | Product of | 1.5 | 24.8 | 5.80 | Although there are a | ◯ |
| | the present | | | | texture of creaminess | |
| | invention | | | | and smoothness, it is a | |
| | | | | | little softly and light. | |
| | Comparative | 1.0 | 15.4 | 5.16 | Although it is slightly | X |
| | product | | | | smooth, it is weak and | |
| | | | | | there is roughness. | |
| | Control | 0.0 | 0.0 | 4.69 | It is slightly soft and | X |
| | product | | | | watery, and rough. | |
| 4.30 | Product of | 2.0 | 30.4 | 6.17 | Creaminess and smooth- | |
| | the present | | | | ness exceeding whole- | |
| | invention | | | | fat. Hardness is | |
| | | | | | equivalent to whole-fat. | |
| | Product of | 1.5 | 23.7 | 6.10 | Sufficient texture of | ⊚ |
| | the present | | | | creaminess, smoothness | |
| | invention | | | | and hardness. | |
| | Product of | 1.0 | 15.6 | 5.93 | Texture of creaminess | ◯ |
| | the present | | | | and roughness are almost | |
| | invention | | | | equivalent to whole-fat. | |
| | Comparative | 0.5 | 9.5 | 5.23 | Although it is slightly | X |
| | product | | | | smooth, it is weak and | |
| | | | | | there is roughness. | |
| | Control | 0.0 | 0.0 | 4.90 | It is slightly watery, | X |
| | product | | | | and rough. | |
| 4.45 | Comparative | 6.0 | 77.9 | 7.95 | Although it is smooth, | X |
| | product | | | | it has not solidified. | |
| | | | | | Different texture from | |
| | | | | | that of whole-fat. Fat | |
| | | | | | is also separated. | |
| | Comparative | 4.5 | 66.5 | 6.48 | It is smooth and too | X |
| | product | | | | soft, so that texture | |
| | | | | | is different from that | |
| | | | | | of whole-fat. Fat is | |
| | | | | | also separated. | |
| | Product of | 1.0 | 16.2 | 6.11 | Sufficient texture of | ⊚ |
| | the present | | | | creaminess, smoothness | |
| | invention | | | | and hardness. | |
| | Product of | 0.5 | 9.5 | 5.60 | Texture of creaminess | ◯ |
| | the present | | | | and roughness are almost | |
| | invention | | | | equivalent to whole-fat. | |
| | | | | | Slightly rough. | |
| | Control | 0.0 | 0.0 | 5.30 | Although hardness is | X |
| | product | | | | almost equivalent to | |
| | | | | | whole-fat, there is | |
| | | | | | rough feeling. | |

Overall evaluation: evaluative standard (Re: texture of creaminess, smoothness)
X: inferior to whole-fat yoghurt
◯: equivalent to whole-fat yoghurt
⊚: a little superior to whole-fat yoghurt
: clearly superior to whole-fat yoghurt

### Example 3

PG was added to low-heat defatted milk powder (Yotsuba Nyugyo Co., protein 35.6%) solution (10% w/w) under the fully deamidating conditions; that is, with 12.5 U per 1 g of protein, and then subjected to reaction at 55° C. for 60 minutes. Subsequently, the enzyme was deactivated by heating in a boiling bath until the temperature reached 80° C., followed by cooling. Further, for powderization, it was subjected to freeze-drying after freezing at −80° C. to prepare PG treated defatted milk powder having 100% deamidation ratio. This PG treated defatted milk powder was dissolved in the low-fat milk so as to have 4.4% of protein content, and the resultant was sterilized by heating at 95° C. for 2 minutes in a boiling bath, and then was cooled to obtain a PG treated defatted milk powder added low-fat milk (the deamidation ratio was 27.6%) (deamidated milk protein addition method).

The low-heat defatted milk powder (Yotsuba Nyugyo Co., protein 35.6%) was added to the low-fat milk (Takanashi Nyugyo Co., milk fat 1.0%, protein 3.3%) to adjust the protein content to 4.4%, and then the PG solution (60 U/ml) was added thereto by 0 U, 1.5 U, and 1.75 U per 1 g of protein in the milk, respectively, in order that the deamidation ratio becomes 20-30%, followed by reaction at 55° C. for 60 minutes. Subsequently, the enzyme was deactivated by heating the resulting mixtures at 95° C. for 2 minutes in a boiling bath, and then the resultant was cooled to obtain low-fat milks having different deamidation ratio (the deamidation ratios were 23.6% and 29.3%) were obtained (pre-incubation method).

The above PG treated defatted milk powder added low-fat milk and the low-fat milk having deamidation ratio of 23.6% or 29.3% was cooled to 47° C., then the starter (Christian Hansen DVS YC-370 17.7 mg/ml of low-fat milk) was added thereto, and stirred completely and poured into sample cups in an amount of 40 g per cup, followed by fermentation in an thermostatic bath kept at 44° C. About 4 hours later, the fermentation was stopped by transferring them into a refrigerator when the pH became 4.6, and set-yoghurts were obtained. The next day, as a measurement of physical property of yoghurt returned to room temperature, adhesiveness thereof was measured by the texture analyzer. Then, they were cooled again in a refrigerator, and subjected to a sensory test by a panel of 5 skilled persons. The results are shown in Table 3. As shown in Table 3, it was recognized that yoghurt having similar deamidation ratio due to the PG treated defatted milk powder addition method (deamidated milk protein addition method) and pre-incubation method have the same degree of the texture of creaminess and smoothness, and also mostly coincident adhesiveness. That is, it was recognized that equivalent texture and physical property can be obtained by controlling the deamidation ratio for the PG treated defatted milk powder addition method and pre-incubation method.

TABLE 3

| | PG | | | | |
|---|---|---|---|---|---|
| | additive | | | | |
| Protein | amount | Deamidation | | Comment for Sensory | Overall |
| content (%) | (μ/gp) | ratio | Adhesiveness | test | evaluation |
| 4.4 | 0 | 0 | 4.91 | Rough. Hardness is almost | X |
| | | | | equivalent to whole-fat. | |
| | 1.5 | 23.6 | 6.53 | Hardness, smoothness and | ◯ |
| | | | | texture of creaminess are | |
| | | | | equivalent to whole-fat. | |
| | 1.75 | 29.3 | 6.59 | A little hard. Smoothness | ⊚ |
| | | | | and texture of creaminess | |
| | | | | are equivalent or superior | |
| | | | | to whole-fat and equivalent | |
| | | | | to modified powdered milk. | |
| | modified | 27.6 | 6.68 | Smoothness and texture of | ⊚ |
| | powdered milk | | | creaminess are equivalent | |
| | | | | or superior to whole-fat. | |
| | | | | Hardness is equivalent to | |
| | | | | whole-fat. | |

Overall evaluation: evaluative standard (Re: texture of creaminess, smoothness)
X: inferior to whole-fat yoghurt
◯: equivalent to whole-fat yoghurt
⊚: a little superior to whole-fat yoghurt
: clearly superior to whole-fat yoghurt

### Comparative Example 1

PG was added to 10% (w/w) solution of whey protein “Bipro” (DAVISCO JE189-7-440. protein 95%) and “Enlact HG” (Nihon Shinyaku Co., protein 80%) as other milk protein under the fully deamidating conditions of PG; that is, by 65.8 U per 1 g of protein in “Bipro” solution and 78.1 U per 1 g of protein in “Enlact HG” solution, respectively, and then subjected to reaction at 50° C. for 60 minutes. Subsequently, the enzyme was deactivated by heating in a boiling bath until the temperature reached 80° C., and then the reactant was cooled. Further, for powderization, it was subjected to freeze-drying after freezing at −80° C. to prepare whey proteins due to the PG treatment. The preparation, which was prepared similarly without enzymatic addition, was made an untreated whey protein.

The PG treated whey protein “Bipro” and the untreated whey protein “Bipro” were dissolved into the low-fat milk (Takanashi Nyugyo Co., milk fat 1.0%, protein 3.3%) to contain protein content 4.1% and 4.7%, respectively; and the PG treated whey protein “Enlact HG” and the untreated whey protein “Enlact HG” were dissolved into the low-fat milk (Takanashi Nyugyo, milk fat 1.0%, protein 3.3%) so as to contain protein content 3.9%, respectively. Then, the resulting dissolved solutions were sterilized by heating at 95° C. for 2 minutes in a boiling bath, and were cooled to 47° C., then the starter (Christian Hansen DVS YC-370 17.7 mg/ml of low-fat milk) was added thereto, stirred completely and poured into sample cups in an amount of 40 g per each cup, followed by fermentation in a thermostatic bath kept at 44° C. About 4 hours later, the fermentation was stopped by transferring them into a refrigerator when the pH became 4.6, and set-yoghurt was obtained. The next day, as a measurement of physical property of yoghurt returned to room temperature, the adhesiveness thereof was measured by the texture analyzer. Then, they were cooled again in a refrigerator, and subjected to a sensory test by a panel of 5 skilled persons. The results are shown in Table 4. As shown in Table 4, although the PG treated whey protein “Bipro” was softer than the untreated one, and became a little smooth, its texture of creaminess and smoothness were weak and the whey smell was strong. In a similar way, the PG treated whey protein “Enlact HG” was softer than the untreated one, and the texture of creaminess and the smoothness were weak.

TABLE 4

| | | PG | | | |
|---|---|---|---|---|---|
| | | additive | | | |
| Protein content | Whey | amount | | Comment for Sensory | Overall |
| (%) | product | (u/gp) | Adhesiveness | test | evaluation |
| 4.1 | WPI | 65.8 | 3.93 | A little | X |
| | “Bipro” | | | soft, smoothness is also | |
| | | | | weak, whey smell is strong | |
| | | 0 | 4.25 | Very hard. | X |
| | | | | Rough and coarse | |
| 4.7 | WPI | 65.8 | 4.04 | Smoothness and texture of | X |
| | “Bipro” | | | creaminess are weak. | |
| | | | | Hardness is almost | |
| | | | | equivalent. Whey smell is | |
| | | | | strong. | |
| | | 0 | 4.29 | Very hard. Roughness. | X |
| | | | | (hardness like agar) | |
| 3.9 | WPC | 78.1 | 4.05 | Soft and watery. whey | X |
| | “Enlact HG” | | | smell. smoothness and | |
| | | | | texture of creaminess, but | |
| | | | | weak. | |
| | | 0 | 3.67 | A little soft, smoothness is | X |
| | | | | weak | |

Overall evaluation: evaluative standard (Re: texture of creaminess, smoothness)
X: inferior to the whole-fat yoghurt

According to the present invention, low-fat or fat-free yoghurts having the richness and creamy texture like yoghurt produced with a material milk in which the amount of fat has not been adjusted (whole-fat milk) can be obtained; thereby, the present invention is useful for the food industries.

It should be noted that changes and modifications of the modes or examples may be done within the entire disclosure (inclusive of the claims) of the present invention and on the basis of the basic technical concept thereof. Also, it should be noted that a variety of combinations or selections of various elements as disclosed may be made within the scope of the claims of the present invention. That is, it should be noted that the present invention also includes various changes and modifications which can be made by a person skilled in the art on the basis of the entire disclosure (inclusive of the claims) and technical concept.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for producing a yoghurt, comprising:
a) adding a casein-containing milk protein to a fat-free milk, which has a milk fat content of 0.0% by weight or more and less than 0.5% by weight, to obtain a milk raw material mixed-solution, which has a milk protein content of 4.5% by weight or more and 4.8% by weight or less;
b) treating said milk raw material mixed-solution with a protein deamidating enzyme, to obtain a deamidated milk raw material mixed-solution in which a deamidation ratio, X, of the milk protein in said deamidated milk raw material mixed-solution meets the following formula:
−19.3×milk protein content (%)+198≦X (%)≦64
and
c) adding a starter to said deamidated milk raw material mixed-solution.

2. A method for producing a yoghurt, comprising:
a) adding a casein-containing milk protein to a fat-free milk, which has a milk fat content of 0.0% by weight or more and less than 0.5% by weight, to obtain a milk raw material mixed-solution, which has a milk protein content of 4.8% by weight or more and 5.0% by weight or less;
b) treating said milk raw material mixed-solution with a protein deamidating enzyme to obtain a deamidated milk raw material mixed-solution in which a deamidation ratio of the milk protein in said milk raw material mixed-solution is 9% or more and 64% or less; and
c) adding a starter to said deamidated milk raw material mixed-solution.

3. A method for producing a yoghurt, comprising:
a) treating a casein-containing milk protein with a protein deamidating enzyme to obtain a deamidated milk protein;
b) adding said deamidated milk protein to a fat-free milk, which has a milk fat content of 0.0% by weigh or more and less than 0.5% by weight, to obtain a milk raw material mixed-solution, which has a milk protein content of 4.5% by weight or more and 4.8% by weight or less, and wherein a deamidation ratio X of the milk protein in said milk raw material mixed-solution meets the following formula:
−39.3×milk protein content (%)+198≦X (%)≦64
and
c) adding a starter to said milk raw material mixed-solution.

4. A method for producing a yoghurt, comprising:
a) treating a casein-containing milk protein with a protein deamidating enzyme to obtain a deamidated milk protein;
b) adding said deamidated milk protein to a fat-free milk, which has a milk fat content of 0.0% by weigh or more and less than 0.5% by weight, to obtain a milk raw material mixed-solution, which has a milk protein content of 4.5% by weight or more and 4.8% by weight or less, and wherein a deamidation ratio X of the milk protein in said milk raw material mixed-solution is 9% or more and 64% or less; and
c) adding a starter to the milk raw material mixed-solution.

5. A method for producing a yoghurt, comprising:
a) adding a casein-containing milk protein to a low-fat milk, which has a milk fat content of 0.5% by weight or more and less than 1.5% by weight, to obtain a milk raw material mixed-solution, which has a milk protein content of 4.0% by weight or more and 4.5% by weight or less;
b) treating said milk raw material mixed-solution with a protein deamidating enzyme to obtain a deamidated milk raw material mixed-solution in which a deamidation ratio X of the milk protein in said deamidated milk raw material mixed-solution meets the following formula:
−44.3×milk protein content (%)+201≦X (%)≦64
and
c) adding a starter to the deamidated milk raw material mixed-solution.

6. A method for producing a yoghurt, comprising:
a) treating a casein-containing milk protein with a protein deamidating enzyme to obtain a deamidated milk protein;
b) adding said deamidated milk protein to a low-fat milk, which has a milk fat content of 0.5% by weight or more and 1.5% by weight or less, to obtain a milk raw material mixed-solution, which has a milk protein content of 4.0% by weight or more and 4.5% by weight or less, and wherein a deamidation ratio X of the milk protein in said milk raw material mixed-solution meets the following formula:
−44.3×milk protein content (%)+201≦X (%)≦64
and
c) adding a starter to the milk raw material mixed-solution.

7. A method according to claim 1, wherein said protein deamidating enzyme is an enzyme derived from the genus Chryseobacterium.

8. A method according to claim 1, wherein said protein deamidating enzyme is added in an amount of 0.01-100 units per 1 g of the milk protein.

9. A method according to claim 1, wherein said milk protein is a defatted milk powder.

10. A yoghurt, which is produced by a method according to claim 1.

11. A yoghurt, which is produced by a method according to claim 2.

12. A yoghurt, which is produced by a method according to claim 3.

13. A yoghurt, which is produced by a method according to claim 4.

14. A yoghurt, which is produced by a method according to claim 5.

15. A yoghurt, which is produced by a method according to claim 6.
